(19) United States
(12) Patent Application Publication
(10) Pub. No.: US 2008/0215505 A1
(43) Pub. Date: Sep. 4, 2008

(54) Car wash communication, fund transfer, control system and method

(76) Inventor: Dale Reynolds, Durham, NC (US)

Correspondence Address: DALE REYNOLDS, 417 S MADISON BLVD, ROXBORO, NC, 27573, US

(21) Appl. No.: 11/711,708

(22) Filed: Feb. 28, 2007

(51) Int. Cl. G06Q 99/00

(52) U.S. Cl. 705/400

(57) ABSTRACT

A method of controlling one or more self service vacuums, dispensers, fragrance machines, shampoo machines, cleaning systems or car wash systems comprising a radio frequency transceiver or module. This method incorporates an RF or radio frequency receiver, transmitter or transceiver. The system has the capability of configuring the various dispensing systems to change pricing and operation. Processing of the various payment methods include coin, currency, credit card, debit card gift, card, fleet card, token, flash memory, electronic payment, special keys, scan cards as well as numerous other payment means. One embodiment is performed over a secure RF system.

### FIELD OF THE INVENTION

The present invention relates to car wash devices. More particularly, the invention relates to providing a means to monitor, control and perform fund transactions between various wash devices, central servers, terminals and bank processing & transaction centers.

### BACKGROUND OF THE INVENTION

A variety of vending systems and controls exist. One widespread example of vending systems and control is the car wash and related equipment such as vacuum, shampoo, fragrance dispensing systems. Each car wash and related dispensing system comprises a means to collect a payment for the service or product provided. Payments may include coin, currency, credit card, debit card gift, card, fleet card, token, flash memory, electronic payment, special keys, scan cards, bar coded cards, IR device, as well as numerous other payment means. The payment transactions are becoming more complex as the variety of payment and accounting methods increase.

The typical car wash owner and operator is becoming more frustrated in his or her endeavor to implement these advance methods. An existing car wash may incorporate a means to realize some of these methods by rewiring the car wash facility only to find out he or she is one generation behind in the technology. In addition much expense may be required to rewire a car wash and related dispensing systems. Consider breaking up a 50 foot concrete parking lot and re-patching in order to route a CAT5 communications cable to the outlying Vacuum Cleaner or Shampooing apparatus associated with the car wash; only to find out a year later that a new fiber optic cable will do a better job. There is therefore a compelling need for a way to make vending systems such as car wash/cleaning systems easier to network, monitor, operate and control.

### BRIEF DESCRIPTION OF TABLES

Table 1 Master packet format

Table 2 Master Command Definition

Table 3 Slave packet format

Table 4 Slave Command Definition

Table 5 Error recovery

Table 6 Communications sequences

Table 7 Credit card sequences

Table 8 Credit status messages

Table 9 Set up sequences

Table 10 Requesting set up sequences

Table 11 Simulate fund increments

Table 12 Request find counter

Table 13 Request to use greeting

Table 14 Download greeting message

### SUMMARY

One embodiment uses the following steps of encryption the RF signal used to communicate to the car wash dispensing systems and the client computer server or central control:

Timer Board encrypts the data being sent to the modem with 4096 combination lock type codes.

We embed a unique security code (there are 264 options) in firmware for each transceiver that is in the Timer Board. Other transceivers will not link up with each other unless their unique security code is identical.

The transceiver operates on a network Channel. This 20 determines the unique pseudo-random hop table all transceivers in the carwash network must follow. The transceiver has over 70 different channels. The transceivers must be on the same unique security code and Channel to establish synchronization. So the potential eavesdropping radio will not even link up with other transceiver unless the Channel number and security code is identical.

Transceiver contains a unique identification number embedded in firmware. Software instructs transceivers to communicate only with transceivers having a specific address. If an eavesdropping radio hears a packet targeted at another transceivers, it will not pass on that data to the host device.

The transceivers communicate on a proprietary protocol that will talk only to other proprietary transceivers and not with transceivers of any other manufacturer. A person wanting to listen to wireless Carwash transactions could not pick up proprietary communication using any other transceiver. The proprietary transceivers transmit for short periods of time on one frequency before hopping to another frequency to continue transmission. These transceivers continuously hop on a pseudo random basis. The transmitting frequency change 10 to 1,000 times a second with no apparent pattern.

Spread Spectrum uses wide band, noise-like signals. Because Spread Spectrum signals are noise-like, they are hard to detect. Spread Spectrum signals are also hard to Intercept or demodulate. Spread Spectrum signals are harder to jam than narrowband signals.

Each transceiver contains a unique secondary identification number that is programmed from the Carwash/Vacuum timer and embedded in firmware. Just as with the hard wired RS422, each carwash bay or vacuum will ignore data transmitted to another bay or vacuum.

The transceiver uses a 56 bit DES (Data Encryption Standard) giving seventy quadrillion possible keys. If it took one second to try each of the keys it would take 2 billion year to try them all.

We also have the ability to change the key on the fly. Going to this extreme may not be necessary and may be adding extra software overhead in the timer.

Another embodiment uses the following communications protocol. This embodiment defines the communications protocol required to perform credit card verification for a carwash system. The following sequence of events will be performed:

A customer will swipe a credit card at a carwash bay.

The controller will communicate the magnetic stripe information to a master PC.

The PC will validate and charge the account.

The PC will signal the carwash bay if the card information was accepted or declined.

Carwash bay informs the customer of the card status, and initiates a wash if accepted.

Additional functions have been incorporated that allow the host to program the carwash set-up variables, request various counters, and program the greeting message.

Carwash Bay Communications

The carwash bay controller acts as a slave device on a full duplex RS422 buss. The master, in this case, being a PC. All communications are initiated by the PC, with a return response sent from the addressed carwash. Information is transferred in packets.

Master Packet Format

TABLE 1

| | | | | | |
|---|---|---|---|---|---|
| Start Byte | Packet Length | Carwash Bay | Command | Data | Checksum |
| | | Address | | | |

Start Byte 0x1B
Packet Length Two byte sum of all bytes, including [checksum], excluding [start byte] and [packet length]. Sent MSB first, followed by LSB.
Carwash Bay Address: Desired carwash bay to communicate. Bay address selected by software configurable registers. Ranging from 0x10 to 0xFF

TABLE 2

| COMMAND | COMMAND DEFINITION | DATA | |
|---|---|---|---|
| 00 | Does addressed bay have | 00 | For future use |
| | credit card data pending | | |
| 01 | Addressed bay's credit card data | 00 | For future use |
| | received, performing validation | | |
| 02 | Addressed bay's credit card | 01 | Approved |
| | status | | |
| | | 02 | Denied |
| | | 03 | Error retry |
| 03 | Terminate transmission, | 00 | For future use |
| | discard card scan information | | |
| 04 | Setup information | XX | Setup data |
| 05 | Request setup information | 00 | For future use |
| 06 | Start a wash cycle | XX | Simulated coin |
| | | | amount & time |
| 07 | Request the coin/bill/test | 00 | For future use |
| 08 | Downloading the greeting | XX | Greeting message |
| | message | | |

Checksum 2 byte sum of all bytes within the packet, beginning with [start byte], but excluding checksum. Sent MSB first, followed by LSB.

TABLE 3
Slave packet format

| | | | | | |
|---|---|---|---|---|---|
| Start Byte | Packet Length | Carwash Bay | Command | Data | Checksum |
| | | Address | | | |

Start Byte: 0x1B
Packet Length Two byte sum of all bytes, including [checksum], excluding [start byte] and [packet length]. Sent MSB first, followed by LSB.
Carwash Bay Address: Responding carwash bay. Bay address selected by software configurable resisters. Ranging from OxOO to OxFF

TABLE 4

| | COMMAND | | |
|---|---|---|---|
| COMMAND | DEFINITION | DATA | |
| 00 | Response code | 00 | No credit card data available |
| | | 01 | Acknowledge |
| 01 | Error command | 00 | Unknown command or |
| | | 01 | invalid data |
| | | 02 | Received OxO 1 command |
| | | | unexpectedly |
| | | | Received 0x02 command |
| | | | unexpectedly |

| | | |
|---|---|---|
| 02 | Credit card | Scanned credit card tracks 1 & 2 |
| | information available | information |
| 03 | Setup information | Setup information |
| 04 | Coin/bill/test counters | Byte order-[coin count] [bill count] |
| | | [test count]. |
| | | All are 2 bytes, hexadecimal msb |
| | | first |

Checksum 2 byte sum of all bytes within the packet, beginning with [start byte], but excluding checksum. Sent MSB first, followed by LSB.

### Credit Card Track Data Contained in Slave Packet

All data is in ASCII format. [Data] is formatted in the following order:
Byte 1 Car wash active status (0x00=inactive, 0x01=active)
Byte 2 Track 1 start sentinel (0x25)
Byte 3 Track 1 information, up to 76 characters
Byte N Track 1 end sentinel (0x3F)
Byte N+1 Track 2 start sentinel (0x3B)
Byte N+2 Track 2 information, up to 37 characters
Byte N Track 2 end sentinel (0x3F)

### Error Recovery

A series of timers are incorporated within the bay controllers to recover from communications errors. Recovery results in the bay discarding the credit card information and entering the idle state waiting for the 0x00 command from the PC.

TABLE 5

| DELAY (sec) | OPERATION |
|---|---|
| 5 | Card swiped, waiting for 0x00 command packet from PC |
| 2 | Bay sends credit card information, waiting for 0x01 |
| | command packet from PC |
| 10 | Waiting for 0x02 or 0x03 command packet from PC |

TABLE 5

### Communication Sequences

TABLE 6
REQUEST FOR CREDIT CARD INFORMATION
(NO CARD SWIPED)

| DIRECTION | COMMAND | DATA | OPERATION |
|---|---|---|---|
| PC to Bay | 00 | 00 | PC asks carwash if |
| | | | credit card |
| | | | information is |
| | | | available |
| Bay to PC | 00 | 00 | Carwash bay signals |
| | | | no credit card data |
| | | | available |

TABLE 7
REQUEST FOR CREDIT CARD INFORMATION (CARD SWIPED)

| DIRECTION | COMMAND | DATA | OPERATION |
|---|---|---|---|
| PC to Bay | 00 | 00 | PC asks carwash if |
| | | | credit card |
| | | | information is |
| | | | available |
| Bay to PC | 02 | Swiped credit card | Send PC the swiped |
| | | information | card information for |
| | | | validation |
| PC to Bay | 01 | 00 | PC received card |
| | | | information, |
| | | | performing validation |
| Bay to PC | 00 | 01 | Received validation |
| | | | command |
| PC to Bay | 02 | 01, 02 or 03 | PC sends bay the card |
| | | | status |
| Bay to PC | 00 | 01 | Received card status |
| | | | command |

TABLE 8
REQUEST TO SCROLL A CREDIT CARD STATUS MESSAGE

| DIRECTION | COMMAND | DATA | OPERATION |
|---|---|---|---|
| PC to Bay | 02 | 01 | Scroll “APPROVED” |
| | | 02 | across the display |
| | | 03 | Scroll “DENIED” |
| | | | across the display |
| | | | Scroll “ERROR, |
| | | | RETRY” across the |
| | | | display |
| Bay to PC | 00 | 01 | Received command |

TABLE 9

| DIRECTION | COMMAND | DATA | OPERATION |
|---|---|---|---|
| PC to Bay | 04 | XX, XX | 1st byte: Coins to start (amount |
| | | | of quarters) 2nd byte: Time to |
| | | | start (increments of 5 seconds) |
| Bay to PC | 00 | 01 | Setup data valid |
| | 01 | 00 | Setup data invalid |

TABLE 10
REQUEST THE CARWASH CONTROLLER SET-UP VARIABLES

| DIRECTION | COMMAND | DATA | OPERATION |
|---|---|---|---|
| PC to Bay | 05 | 00 | Requesting setup information |
| Bay to PC | 03 | XX, XX | 1st byte: Coins to start (amount |
| | | | of quarters) |
| | | | 2nd byte: Time to start |
| | | | (increments of 5 seconds) |

TABLE 11
SIMULATE THE INSERTION OF QUARTERS

| DIRECTION | COMMAND | DATA | OPERATION |
|---|---|---|---|
| PC to Bay | 06 | XX, XX | 1st byte: Simulated quarters |
| | | | (1-100) |
| | | | 2nd byte: Amount of total time |
| | | | to add (5 second steps). If value |
| | | | is 00, then the normal calculated |
| | | | time/quarter value is used |
| Bay to PC | 01 | 01 | Amount valid and accepted |
| | | 00 | Amount invalid and discarded |

TABLE 12
REQUEST THE COIN/BILL/TEST COUNTERS

| DIRECTION | COMMAND | DATA | OPERATION |
|---|---|---|---|
| PC to Bay | 07 | 00 | Requesting coin/bill/test |
| | | | counters |
| Bay to PC | 04 | XX, XX, | 1st and 2nd bytes: Coin counter |
| | | XX, XX, | (hexadecimal msb first) |
| | | XX, XX | 3rd and 4th bytes: Bill counter |
| | | | (hexadecimal msb first) |
| | | | 5th and 6th bytes: Test counter |
| | | | (hexadecimal msb first) |

TABLE 13
REQUEST CARWASH TO USE PREPROGRAMMED
GREETING MESSAGE

| DIRECTION | COMMAND | DATA | OPERATION |
|---|---|---|---|
| PC to Bay | 08 | 00 | Use greeting message |
| | | | provided by carwash |
| | | | controller |
| Bay to PC | 00 | 01 | Received command |

TABLE 14
DOWNLOAD GREETING MESSAGE

| DIRECTION | COMMAND | DATA | OPERATION |
|---|---|---|---|
| PC to Bay | 09 | XX (up to 60 | Byte: 0x00-0x1f |
| | | characters) | Byte: 0x20-0x7E |
| | | | Byte: 0x7F Ignored |
| | | | Byte: 0x80 Display money to |
| | | | start (2 seconds) |
| | | | Byte: 0x81-0xFF |
| | | | A packet where the 1~ data |
| | | | byte is a non-displayable |
| | | | ASCII character will |
| | | | command the controller to |
| | | | scroll the internal canned |
| | | | message. |
| Bay to PC | 00 | 01 | Received command |

And another embodiment uses ether 2.4 GHz or 900 MHz radio frequency. The following summarizes the characteristics of the radio frequency methods:

Common antenna size for the 2.4 GHz is 5″, 900 MHz is 7″. The actual ½ wave Dipole inside the antenna housing for the 2.4 GHz is about ⅓rd the size of the 900 MHz, not reflected in housing.

2.4 GHz versus 900 MHz Penetrating Obstacles. Radio waves decrease in amplitude as they pass through walls. As the radio frequency increases, the rate of attenuation increases that is, the radio strength attenuates faster, and the effect of passing through obstacles is much greater.

2.4 GHz versus 900 MHz Bending around Obstacles. Radio waves travel in a straight line, however a radio “beam” can diffract or bend when it hits an edge in the same way as light can. The angle of diffraction is higher as frequency decreases or the ability to bend around obstacles increases as frequency decreases.

2.4 GHz versus 900 MHz Reflections Radio waves also reflect from dense surfaces such as metallic walls or vessels. Very often the radio signal has been reflected several times before it reaches the receiver unit. When a radio signal is reflected, some of the RE power is absorbed by the obstacle, reducing, or attenuating, the strength of the reflected signal. This attenuation increases with frequency. That is, the reflected signal is weaker for higher frequencies. If the path is very congested, with a lot of consecutive reflections, the 2.4 GHz signal fades out quickly.

The end result of the effects of RF power, propagation losses, penetration attenuation, de-fraction and reflection loss is that 2.4 GHz has only a very short reliable operating distance in industrial environments with reliable distances of only around 10-20% of the lower frequency bands. That is, the lower frequency bands reach 5-10 times the distance in plants and factories. In many applications, distances of more than 30-100 meters (100-300 feet) cannot be achieved with 2.4 GHz over congested obstructed paths. For typical operating distance in the different ISM bands, refer to the table at the end of this article.

The advantages of 2.4 GHz is high speed. The much wider channels at 2.4 GHz allow a much higher data rate which cannot be matched by the lower frequencies. For industrial applications over short distance but requiring maximum speed, 2.4 GHz is the best choice.

Line-of-sight paths

2.4 GHz, 1 W plus 6 dB gain antennas 5.15 miles

900 MHz, 1 W plus 6 dB gain antennas 15 .25 miles
Heavily congested industrial paths

2.4 GHz, 1 W 100 .600 feet

900 MHz, 1 W 500 .5000 feet

And yet another embodiment incorporates a method of configuring via access buttons on the car wash vending control as follows:
ADJ±(ADJ _and ADJ+)/MODE SWITHCES

DOLLAR COUNTS

To View Coin, Bill and Credit Card Count PUSH ADJ+ BUTTON.

| | |
|---|---|
| Displays Advances: | COIN XXXX (254~ = 1) |
| | BILL XXXX ($1.00 = 4) |
| | CARD XXXX ($1.00 = 4) |
| | TEST XXXX (number of times activated) |
| | TOTL XXXX (total of Coin, Bill & Card) |
| exits | |

To Clear Press the ADJ _BUTTON while TOTL is being Displayed.

To Clear TEST Press the ADJ _BUTTON while TOTL is being Displayed PROGRAMMING.

To Set up Programming use the MODE Switch to advance to each programming function and the ADJ± Switch to make the adjustment.

| 1 | COIN (displayed for reference) | |
|---|---|---|
| 2 | Adjust Number of quarters needed to start wash $0.25 to $20.00 | |
| 3 | TIME (displayed for reference) | |
| 4 | Adjust Total Time per wash (0-20:00) 5 sec increments | |
| 5 | ALRT (displayed for reference) | |
| 6 | Time for Alert Horn (12 Volt DC) (0-1:00) 5 sec increments | |
| 7 | TEST (displayed for reference) | |
| 8 | Number of minutes of Test Time (0-9:00) | |
| 9 | BONS (displayed for reference) | |
| 10 | Number of seconds per coin of BONUS Time added to each quarter | |
| | after minimum “start” time is purchased (0-1:00) 5 sec increments | |
| 11 | GRAC (displayed for reference) | |
| 12 | Time for Grace (0-30) 5 sec increments | |
| 13 | PAS 1 (displayed for reference) | |
| | PIN# for Remote Test. PIN# (default 2, 0, 0, 5) | |
| 14 | First number of Remote Code (1-9) | Default 2 bXXX |
| 15 | Second number of Remote Code (1-9) | Default 0 XbXX |
| 16 | Third number of Remote Code (1-9) | Default 0 XXbX |
| 17 | fourth number of Remote Code (1-9) | Default 5 XXXb |
| 18 | PAS2 (displayed for reference) | |
| | PIN# for Remote Access. PIN# (default 9, 8, 1, 2) | |
| 19 | First number of Remote Code (1-9) | Default 9 bXXX |
| 20 | Second number of Remote Code (1-9) | Default 8 XbXX |
| 21 | Third number of Remote Code (1-9) | Default 1 XXbX |
| 22 | fourth number of Remote Code (1-9) | Default 2 XXXb |

| 23 | ADDR BAY ADDRESS SETUP 00 to 99 | | |
|---|---|---|---|
| 24 | Select fist digit | 0-9 | bX |
| 25 | Select second digit | 0-9 | Xb |
| 26 | Exit. | | |

And yet other additional embodiment incorporates a method of configuring via infra red remote access on the car wash vending control as follows:

Enter four digit PIN. Default 2005. Press Enter Button. Washes for 9:00 Max. Push Mute Button to Stop.

VIEW DOLLAR COUNT

| Enter four digit PIN. Default 9812. Pressing Vol+ Button | | |
|---|---|---|
| Displays Advances: | COIN XXXX | ($.25 = 1) |
| | BILL XXXX | ($1.00 = 4) |
| | CARD XXXX | ($1.00 = 4) |

TEST XXXX (number of times activated)
TOTL XXXX (total of Coin, Bill & Card)
Exits

### PROGRAMMING.

To Set up Programming Key in PASSWORD #2 (default 9812) use the ENTER Button to advance to each programming function and the Vol± Switch to make the adjustment.

| 1 | COIN (displayed for reference) | |
|---|---|---|
| 2 | Adjust Number of quarters needed to start wash $0.25 to $20.00. | |
| 3 | TIME (displayed for reference) | |
| 4 | Adjust Total Time per wash (0-20:00) 5 sec increments | |
| 5 | ALRT (displayed for reference) | |
| 6 | Time for Alert Horn (12 Volt DC) (0-1:00) 5 sec increments | |
| 7 | TEST (displayed for reference) | |
| 8 | Number of minutes of Test Time (0-9:00) | |
| 9 | BONS (displayed for reference) | |
| 10 | Number of seconds per coin of BONUS Time added to each quarter | |
| | after minimum “start” time is purchased (0-1:00) 5 sec increments | |
| 11 | GRAC (displayed for reference) | |
| 12 | Time for Grace (0-30) 5 sec increments | |
| 13 | PAS 1 (displayed for reference) | |
| | PIN# for Remote Test. PIN# (default 2, 0, 0, 5) | |
| 14 | First number of Remote Code (1-9) Default 2 | bXXX |
| 15 | Second number of Remote Code (1-9) Default 0 | XbXX |
| 16 | Third number of Remote Code (1-9) Default 0 | XXbX |
| 17 | fourth number of Remote Code (1-9) Default 5 | XXXb |
| 18 | PAS2 (displayed for reference) | |
| | PIN# for Remote Access. PIN# (default 9, 8, 1, 2) | |
| 19 | First number of Remote Code (1-9) Default 9 | bXXX |
| 20 | Second number of Remote Code (1-9) Default 8 | XbXX |
| 21 | Third number of Remote Code (1-9) Default 1 | XXbX |
| 22 | fourth number of Remote Code (1-9) Default 2 | XXXb |

| | |
|---|---|
| 23 | ADDR BAY ADDRESS SETUP 00 to 99 |
| 24 | Select fist digit 0-9 bX |
| 25 | Select second digit 0-9 Xb |
| 26 | Exit. |

1. A car wash comprising: car wash equipment configured to perform a car wash function in response to a car wash control signal; and a car wash controller in operative communication with the car wash equipment, and comprising: a controller input configured to receive a plurality of fund inputs, each representative of a respective monetary value; an evaluator configured to assign a plurality of credit values respectively to each of the fund inputs, wherein a communication means is incorporated to provide:
Updated displayed messages to the independent car wash control units
Update the amount of money required to start a car wash cycle
Update the amount of time associated with an amount of money
Accumulated balance of funds and type of funds deposited at the control unit The carwash equipment may also be vacuum cleaner, fragrance dispenser, or carpet cleaner.

2. The apparatus of claim 1 wherein the communication means is accomplished by radio frequency transmission.

3. The apparatus of claim 1 wherein the communication means is accomplished by power line modulation.

4. The apparatus of claim 1 wherein the communication means is accomplished by IR infra red transmission.

5. The apparatus of claim 1 wherein the fund input of the preferred form comprises paper currency of at least a minimum denomination.

6. The apparatus of claim 1 wherein the fund input of the preferred form comprises a credit card payment.

7. The apparatus of claim 1 wherein the fund input of the preferred form comprises an electronic fund transfer.

8. The apparatus of claim 1 further comprising a display, in operative communication with the car wash controller, for communicating information about the accumulation of the fund values.
